(19) United States
(12) Patent Application Publication
(10) Pub. No.: US 2026/0145108 A1
(43) Pub. Date: May 28, 2026

(54) COMPONENT FOR A FILTER UNIT

(71) Applicant: Carl Freudenberg KG, Weinheim (DE)

(72) Inventors: Sascha SCHUMACHER, Wald-Michelbach (DE); Stefan KLUCK, Rheinmünster (DE)

(21) Appl. No.: 19/387,820

(22) Filed: Nov. 13, 2025

(30) Foreign Application Priority Data
Nov. 25, 2024 (DE) 10 2024 134 664.7

(51) Int. Cl. B01D 46/00; B01D 46/24

(52) U.S. Cl. CPC B01D 46/0047; B01D 46/2414

(57) ABSTRACT

A component for a filter unit, where the component is arranged in an air stream that flows through the filter unit at least in part, and where the component comprises a plurality of profiles at least in a predetermined region. The plurality of profiles are arranged relative to one another on the basis of a predetermined pattern, where the plurality of profiles are configured at least in part to form a turbulent boundary layer in order to reduce a flow resistance of the air stream at the component.

### CROSS REFERENCE TO RELATED APPLICATIONS

This application claims benefit to German Patent Application No. DE 102024134 664.7, filed on November 25, 2024, which is hereby incorporated by reference herein.

### FIELD

The present invention relates to a component for a filter unit, to a filter unit, and to an air purification system.

### BACKGROUND

Currently, there are many different solutions for forming air conduction components on filter assemblies. Owing to the increasing number of air filters in the field of air purification systems and also the greater quality and power requirements, the need for innovative and robust air conduction solutions is constantly growing.

### SUMMARY

In an embodiment, the present disclosure provides a component for a filter unit, where the component is arranged in an air stream that flows through the filter unit at least in part, and where the component comprises a plurality of profiles at least in a predetermined region. The plurality of profiles are arranged relative to one another on the basis of a predetermined pattern, where the plurality of profiles are configured at least in part to form a turbulent boundary layer in order to reduce a flow resistance of the air stream at the component.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1 and 3 show a component according to an embodiment of the present disclosure;

FIGS. 2 and 4 show a filter unit according to an embodiment of the present disclosure; and

FIG. 5 shows an air purification system according to an embodiment of the present disclosure.

### DETAILED DESCRIPTION

An improved component for a filter unit can advantageously be provided by an embodiment of the present disclosure.

An embodiment of the present disclosure optimizes the differential pressure between an air inlet side and an air outlet side of the component. Thus, an air stream can be prevented from separating from the surface of the component at an earlier point, in particular by means of the plurality of profiles. Further preferably, using the component, it is possible to reduce the energy losses which may occur essentially owing to eddies being generated when the air stream exits the component.

In an embodiment of the present disclosure, the component for a filter unit can be arranged in an air stream that flows through the filter unit at least in part, the component having a plurality of profiles at least in a predetermined region, which profiles are arranged relative to one another on the basis of a predetermined pattern, the plurality of profiles being configured at least in part to form a turbulent boundary layer in order to reduce a flow resistance of the air stream at the component.

In other words, a turbulent boundary layer which can improve the flow properties of the air stream can be formed by means of the plurality of profiles. For example, in cooperation with the predetermined pattern, the plurality of profiles can be configured and positioned relative to one another such that they can form a golf ball structure, a sharkskin, or the like. Preferably, the profiles can be recesses, convexities, or the like. The predetermined pattern defines the relative positions of the profiles. In the event that the profiles are spherical recesses, the midpoint of any of these recesses can be used as a reference for the pattern such that a plurality of mutually adjoining recesses can be produced. By means of the golf ball structure, for example, a turbulent boundary layer can be produced when the air stream flows past the plurality of predetermined profiles. Owing to the turbulent boundary layer at the plurality of profiles, the air stream remains in contact with the surface for a longer period of time compared with previous solutions or a smooth surface. For example, the plurality of profiles can be made by means of an injection mold when the component is molded. Further preferably, the component can be a housing element of a filter unit.

Further preferably, each of the plurality of profiles has a substantially spherical recess.

One advantage of this embodiment is that, by using an adapted plastics injection mold, the spherical recesses can be made in the component relatively simply when it is molded, thereby keeping production costs for the component low even when while giving the component greater functionality. Further preferably, the term “substantially spherical recesses” may also include recesses or the like which are globular, part-spherical, dome-shaped, or the like.

Further preferably, the plurality of substantially spherical recesses, in cooperation with the predetermined pattern, are configured to form a golf ball structure in order to form the turbulent boundary layer.

One advantage of this embodiment is that the golf ball structure can be readily adapted to the particular throughflow rate through the component. Preferably, the recesses can be formed as so-called dimples, which form a structure that reduces the surface friction. The recesses create small regular turbulences, which detach the flow from the component and reduce the overall resistance. The turbulent boundary layer can be formed by the plurality of regular turbulences. Further preferably, the pressure differences at the component can be reduced further by interaction between guide ribs and the plurality of recesses.

Further preferably, the component has a first surface and a second surface, the first surface and the second surface being arranged substantially orthogonally to one another, the predetermined region being a transition region between the first surface and the second surface.

One advantage of this embodiment is that the effort required to make the profiles can be kept low since the profiles would only need to be arranged in the transition region, in view of the finding that the profiles in this region are particularly effective. Preferably, the first surface can be arranged substantially orthogonally to the second surface.

Further preferably, the turbulent boundary layer is configured to keep the air stream on the component at least in part in the predetermined region in a direction of flow of the air stream such that a point at which the air stream separates from the component is shifted in the direction of flow and along the predetermined region.

One advantage of this embodiment is that the air stream is kept on the component for a longer period of time, thus further reducing the flow resistance. Further preferably, the component can have, at least in part, a nozzle that widens along the air stream such that the turbulent boundary layer keeps the air stream on the increasing diameter of the nozzle for a longer period of time.

Preferably, the component has a first section and a second section, the first section being able to be arranged inside the filter unit, the second section being able to be arranged outside the filter unit, the second section having the predetermined region which has the plurality of profiles, the first section having a second plurality of profiles which are configured to form a second turbulent boundary layer in order to reduce the flow resistance at the component in the first section.

One advantage of this embodiment is that both the number and the shape of the profiles can be adapted to each section depending on the position of the section in question. Thus, different flow conditions can be dealt with in a targeted manner.

Further preferably, the component has a constriction between the first section and the second section, the second turbulent boundary layer in the first section being configured to reduce the flow resistance of the air stream toward the constriction, the turbulent boundary layer in the second section being configured to reduce the flow resistance of the air stream away from the constriction.

One advantage of this embodiment is that the flow rates of the air stream differ on the basis of the different cross sections of the component in the first section and in the second section such that the loss in effectiveness or the overall pressure loss can be reduced by specifically adapting the respective turbulent boundary layers in the first and second sections.

Further preferably, the turbulent boundary layer and the second turbulent boundary layer are different from one another. Preferably, the first section has a first action and the second section has a second action, the action of the first section being configured to support the formation of the second turbulent boundary layer whereas the action of the second section is configured to support the formation of the turbulent boundary layer.

Further preferably, the plurality of profiles, in connection with the predetermined pattern, is configured to form a sharkskin.

One advantage of this embodiment is that, by means of the sharkskin, a bionic means is provided for reducing the flow resistance at the component.

A further aspect of the present disclosure relates to a filter unit having a filter element and a component as described herein, the filter unit being configured to filter a predetermined selection of elements out of an air stream by means of the filter element, the filter unit being configured to guide the air stream through the filter element and the component.

For example, the filter element may be a cartridge filter or the like. Preferably, the component may be inserted into the filter element at least in part, such that an air stream can be conducted through the filter unit and exits through the component at least in part.

A further aspect of the present disclosure relates to an air purification system having a component as described herein and/or a filter unit as described herein.

Furthermore, it should be noted that the term “unit” in the present case is likewise to be construed in the broad sense and includes both a one-piece configuration and a multi-piece configuration of the units in question, with each sub-unit not having to be provided at one position in the filter unit or air purification system but also being able to be provided in a manner distributed around the filter unit or air purification system.

All disclosures described herein in relation to one aspect of the present disclosure apply, mutatis mutandis, to all other aspects of the present disclosure.

The drawings are merely schematic and not true to scale. In the drawings, identical, functionally identical, or similar elements may be used with the same reference numerals.

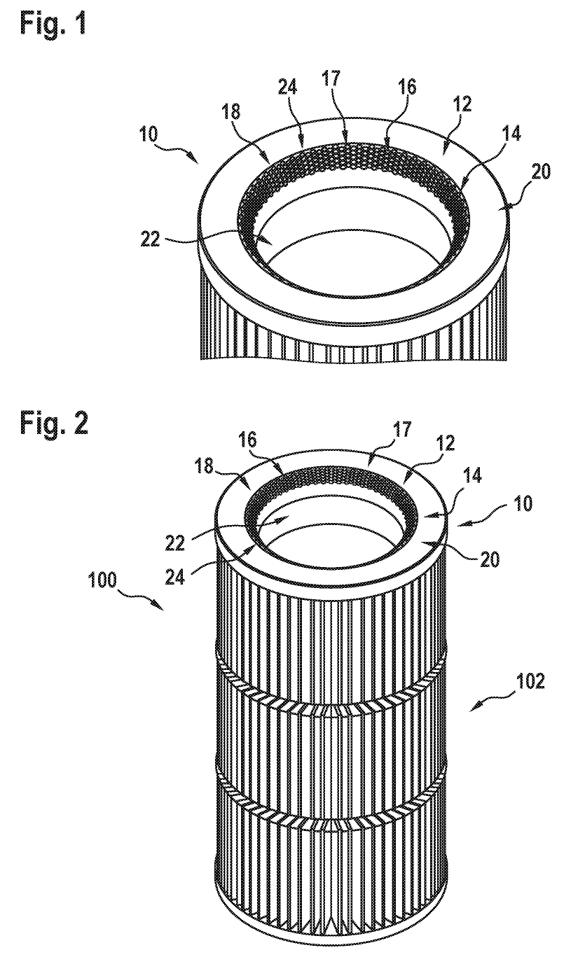

FIG. 1 shows a component 10 according to an embodiment of the present disclosure. The component 10 for a filter unit 100 can be arranged in an air stream that flows through the filter unit 100 at least in part, the component 10 having a plurality of profiles 14 at least in a predetermined region 12, which profiles are arranged relative to one another on the basis of a predetermined pattern 16, the plurality of profiles 14 being configured at least in part to form a turbulent boundary layer in order to reduce a flow resistance of the air stream at the component 10.

As can be seen in FIG. 1, the plurality of profiles 14 can be formed as substantially spherical recesses 17. When the spherical recesses 17 are arranged using the predetermined pattern 16, they can form a golf ball structure 18, as shown in FIG. 1. Further preferably, the component 10 in FIG. 1 has a first surface 20 and a second surface 22, which are arranged substantially orthogonally to one another. In this case, the predetermined region 12 in which the plurality of profiles can be arranged may be in a transition region 24, the transition region 24 being between the first surface 20 and the second surface 22. As shown in FIG. 1, the transition region 24 may be a rounding or the like between the first surface 20 and the second surface 22.

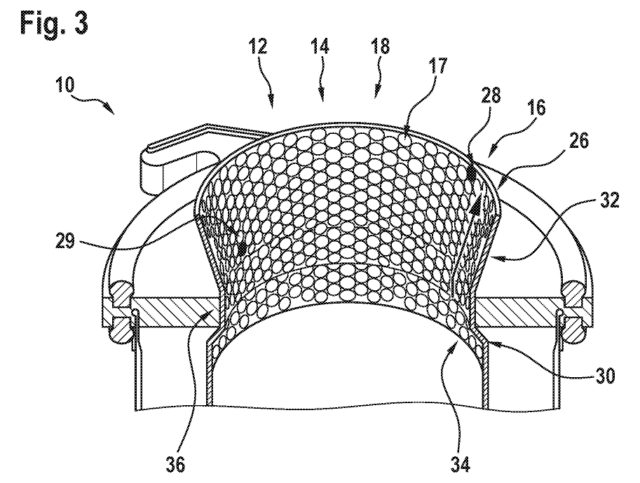

FIG. 2 shows a filter unit 100 according to an embodiment of the present disclosure. Preferably, the filter unit 100 has a filter element 102 on which the component 10 is arranged. Preferably, the component 10 has a plurality of profiles 14 at a predetermined region 12, which profiles are arranged relative to one another on the basis of a predetermined pattern 16, such that the plurality of profiles 14 can form a turbulent boundary layer in order to reduce the flow resistance of the air stream at the component. In this case, for example, the air stream may first flow through the filter element and then reach the surroundings from the interior of the filter element 102 through the component 10.

FIG. 3 shows a component 10 according to an embodiment of the present disclosure. The component 10 has a first section 30 and a second section 32, the first section 30 being able to be arranged inside the filter unit 100 and the second section 32 being able to be arranged outside the filter unit 100. Further preferably, the second section 32 has the predetermined region 12 having the plurality of profiles 14, which are arranged relative to one another on the basis of a predetermined pattern 16, in order thus to be able to form the turbulent boundary layer. Further preferably, the first section 30 has a second plurality of profiles 34, which in particular can be arranged on the basis of a further predetermined pattern in order to form a second turbulent boundary layer. Thus, the flow resistance of the component 10 can be reduced further. Further preferably, the component 10 has a constriction 36 between the first section 30 and the second section 32. In this case, the second turbulent boundary layer can preferably be configured to reduce the flow resistance of the air stream toward the constriction 36, whereas the turbulent boundary layer of the second section 32 reduces the flow resistance of the air stream away from the constriction 36. Preferably, the turbulent boundary layer can be configured to keep the air stream on the component 10 in the predetermined region 12 in a direction of flow 26 of the air stream such that a point 28 at which the air stream separates from the component 10 is shifted in the direction of flow 26 and along the predetermined region 12. FIG. 3 indicates an example point 29 at which the air stream might detach when a plurality of profiles 14 is not provided. By arranging the plurality of profiles 14, the air stream can be kept on a surface of the component 10 in the direction of flow 26 for a longer period of time in order thus to reduce the flow resistance further.

FIG. 4 shows a filter unit 100 according to an embodiment of the present disclosure. The filter unit 100 has a component 10 as described herein, and a filter element 102. Preferably, an air stream can flow through the filter element 102 and then through the component 10.

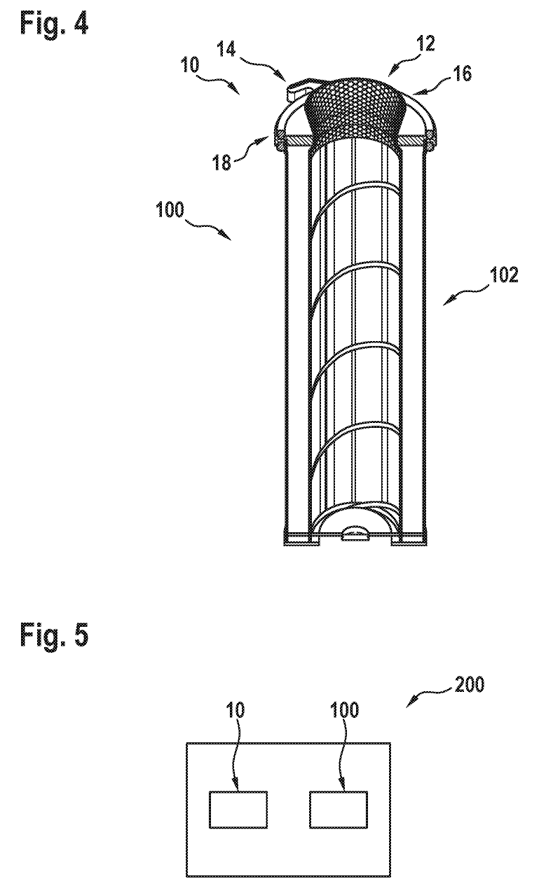

FIG. 5 shows an air purification system 200 according to an embodiment of the present disclosure. The air purification system 200 preferably has a filter unit 100 and/or a component 10 as described herein.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A component for a filter unit, wherein the component is arranged in an air stream that flows through the filter unit at least in part, wherein the component comprises a plurality of profiles at least in a predetermined region, wherein the plurality of profiles are arranged relative to one another on the basis of a predetermined pattern, and wherein the plurality of profiles are configured at least in part to form a turbulent boundary layer in order to reduce a flow resistance of the air stream at the component.

2. The component according to claim 1, wherein each of the plurality of profiles has a substantially spherical recess.

3. The component according to claim 2, wherein the plurality of substantially spherical recesses, in cooperation with the predetermined pattern, are configured to form a golf ball structure in order to form the turbulent boundary layer.

4. The component according to claim 1, wherein the component comprises a first surface and a second surface, wherein the first surface and the second surface are arranged substantially orthogonally to one another, wherein the predetermined region is a transition region between the first surface and the second surface.

5. The component according to claim 1, wherein the turbulent boundary layer is configured to keep the air stream on the component at least in part in the predetermined region in a direction of flow of the air stream such that a point at which the air stream separates from the component is shifted in the direction of flow and along the predetermined region.

6. The component according to claim 1, wherein the component comprises a first section and a second section, wherein the first section is arranged inside the filter unit, wherein the second section is arranged outside the filter unit, wherein the second section includes the predetermined region which has the plurality of profiles, and wherein the first section includes a second plurality of profiles which are configured to form a second turbulent boundary layer in order to reduce the flow resistance at the component in the first section.

7. The component according to claim 6, wherein the component includes a constriction between the first section and the second section, wherein the second turbulent boundary layer in the first section is configured to reduce the flow resistance of the air stream toward the constriction, wherein the turbulent boundary layer in the second section is configured to reduce the flow resistance of the air stream away from the constriction.

8. The component according to claim 1, wherein the plurality of profiles, in cooperation with the predetermined pattern, are configured to form a sharkskin.

9. A filter unit having a filter element and a component according to claim 1, wherein the filter unit is configured to filter a predetermined selection of elements out of an air stream via the filter element, wherein the filter unit is configured to guide the air stream through the filter element and the component.

10. An air purification system having a component according to claim 1.
